(19) United States
(12) Patent Application Publication
(10) Pub. No.: US 2007/0159667 A1
(43) Pub. Date: Jul. 12, 2007

(54) Image reading apparatus with an alignment unit

(75) Inventors: Dong-su Nam, Suwon-si (KR); Myung-bo Son, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/634,162

(22) Filed: Dec. 6, 2006

(30) Foreign Application Priority Data
Jan. 9, 2006 (JP) 10-2006-0002365

(51) Int. Cl. H04N 1/04

(52) U.S. Cl. 358/474; 358/498

(57) ABSTRACT

An image reading apparatus with an alignment unit is provided. The image reading apparatus includes a main body, a roller having a rotation shaft supported by a bushing to be disposed substantially parallel to a main scanning direction, and a scanning module facing the roller. An alignment unit is guided by the rotation shaft to align the scanning module. Accordingly, location accuracy of the roller is improved, exact alignment is possible, and the number of components is reduced because the alignment unit is formed integrally with the scanning module.

### CROSS-REFERENCE TO RELATED PATENT APPLICATION

This application claims the benefit under 35 U.S.C. §119(a) of Korean Patent Application No. 10-2006-0002365, filed on Jan. 9, 2006, in the Korean Intellectual Property Office, the entire disclosure of which is hereby incorporated by reference.

### BACKGROUND OF THE INVENTION

1. Field of the Invention

The present invention relates to an image reading apparatus. More particularly, the present invention relates to an image reading apparatus with an alignment unit to align a scanning module reading an image of a document substantially parallel to a main scanning direction.

2. Description of the Related Art

Generally, examples of image reading apparatuses include scanners, copiers, facsimiles, and multifunction printers combining the functions of the aforementioned devices. The image reading apparatus includes a scanning module for reading an image of a document. The scanning module reads a document along a virtual scanning line, one line at a time. In a type of image reading apparatus in which an image is read while a document is moved and the scanning module does not move, a conveying direction of the document should be perpendicular to the scanning line. When the scanning line is not perpendicular to the conveying direction of the document, the document may be obliquely read.

When a roller faces an upper side of the scanning module and a document is conveyed, the document may deviate from a prearranged conveying direction when the roller is not perpendicular to a conveying direction of the document. Thus, the document may be obliquely read, and may be jammed in the conveying path.

That is, when alignment of the scanning module or the roller facing the scanning module deviates from a prescribed direction, a document may be conveyed askew or read obliquely, and consequently, the accuracy of an image quality decreases. However, alignment of a complicated structure having a lot of components is not preferred in that it increases the cost of the image reading apparatus and makes miniaturization of the image forming apparatus difficult.

Accordingly, a need exists for an image reading apparatus having an improved alignment unit to substantially prevent decreased image quality due to misalignment of a document or scanning module.

### SUMMARY OF THE INVENTION

An exemplary embodiment of the present invention provides an image reading apparatus aligning a scanning module and a roller with a simple structure having a small number of components.

According to an aspect of the present invention, an image reading apparatus includes a main body in which a conveying path of a document is formed, and a roller is rotatably supported in the main body to convey the document in a sub scanning direction while rotating around a rotation shaft. A scanning module faces the roller and reads the document along a virtual scanning line. An alignment unit is formed integrally with the scanning module and is guided by the rotation shaft, thereby aligning a scanning line of the scanning module and the roller in a substantially parallel direction.

The alignment unit may include restriction units disposed at both end portions of the scanning module along the scanning line. Each of the restriction units may include a pair of protrusions disposed at an axially symmetrical position with respect to the scanning line to contact and support the rotation shaft.

The pair of protrusions may contact an outer circumference of the rotation shaft at opposite positions in a radial direction of the rotation shaft.

The image reading apparatus may further include an elastic member applying an elastic force to the scanning module to contact the scanning module with the roller.

The scanning module may include a hinge member hinging the scanning module to the main body.

The roller may extend longer than a maximum width of a readable document. An outer circumference of the roller may have white color such that a peripheral region of the document is read as white color.

The scanning module may include a contact image sensor (CIS) reading an image at a position closely adhered to a surface of the document.

The image reading apparatus may further include a printing unit for printing an image on a printable medium.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of an image reading apparatus according to an exemplary embodiment of the present invention;

FIG. 2 is a side elevational view in partial cross section of an image reading apparatus according to an exemplary embodiment of the present invention;

FIG. 3 is an exploded perspective view of an alignment unit according to an exemplary embodiment of the present invention; and

FIG. 4 is a top plan view of an alignment unit according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described more fully with reference to the accompanying drawings. The invention may, however, be embodied in many different forms and should not be construed as being limited to the exemplary embodiments set forth herein.

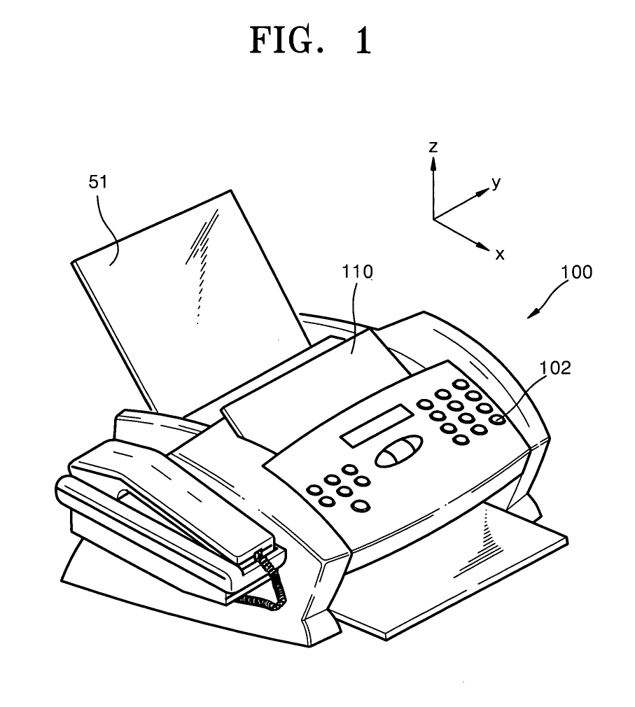

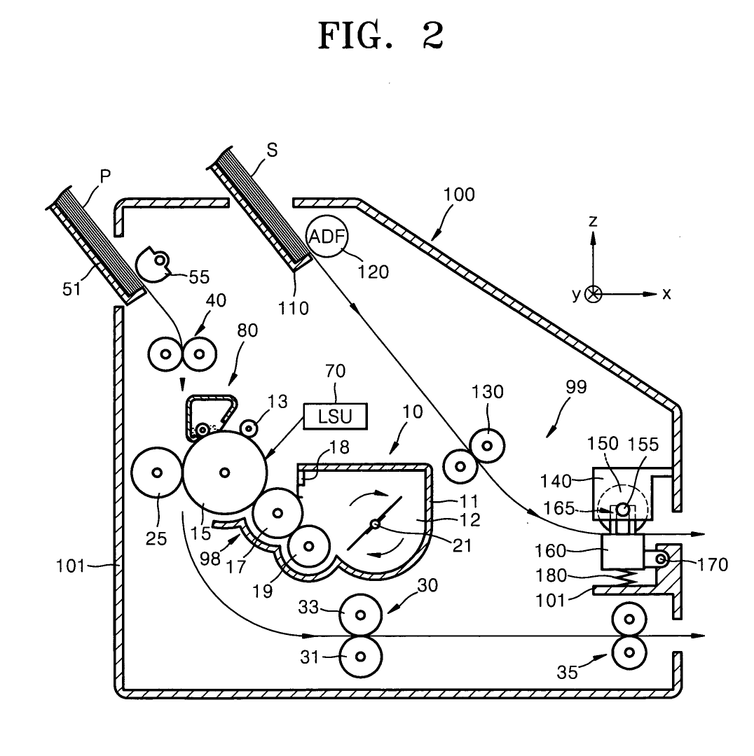

FIG. 1 is a perspective view of an image reading apparatus according to an exemplary embodiment of the present invention. FIG. 2 is a side elevational view in partial cross section of an image reading apparatus according to an exemplary embodiment of the present invention. Referring to FIGS. 1 and 2, the image reading apparatus 100 according to an exemplary embodiment of the present invention includes a scanning unit 99 that reads an image of a document using a scanning module 160. When the image reading apparatus 100 is a multifunction printer performing a printing, the image reading apparatus 100 may further include a printing unit 98 that prints an image on a printable medium P. Although the drawings exemplarily show that the printing unit 98 is a monochrome electro-photographic printing unit, the printing unit is not so limited and any suitable printing unit, such as an inkjet printer or an electro-photographic printing unit, capable of color printing may be utilized in an exemplary embodiment of the present invention.

The printing unit 98 includes a feeding tray 51 to load a printable medium P, a pickup roller 55 to pick up a printable medium P, a laser scanning unit (LSU) 70, a developer 10, a transfer roller 25, a waste toner collector 80, and a fuser 30.

The pickup roller 55 picks up a printable medium P loaded on the feeding tray 51 one by one and conveys the printable medium P towards an aligner 40. The aligner 40 aligns the printable medium P picked up and controls when the printable medium P starts going into the facing surface of the transfer roller 25 and a photoconductor 15.

A charging bias voltage is applied to a charging roller 13 such that the charging roller 13 charges the photoconductor 15 to a predetermined electric potential. The LSU 70 scans a laser corresponding to the image information to be printed onto an outer circumferential surface in response to a computer signal to form an electrostatic latent image.

The developer 10 is mounted detachably inside of the main body 101. The developer 10 includes a cartridge frame 11 forming the exterior of the developer. A developing roller 17, supplying roller 19, an agitator 21, and a toner layer controller 18 are provided in the cartridge frame 11. A toner receiving portion 12 receives the toner, which is a developing agent, and is formed in the cartridge frame 11. The developer 10 is replaced by a new one when the toner received in the toner receiving portion 12 is depleted. The agitator 21 conveys the toner towards the supplying roller 19, agitating the toner with a predetermined pace to substantially prevent the toner in the toner receiving portion 12 from becoming hard. The supplying roller 19 adheres the toner received in the toner receiving portion 12 to the developing roller 17, rotating in a predetermined direction. A supplying bias voltage is applied to the supplying roller 19 to supply the toner to the developing roller 17. The toner layer controller 18 controls a thickness of the toner adhered to an outer circumferential surface and rubs and charges the toner to a predetermined polarity. A developing bias voltage is applied to the developing roller 17 to supply the toner to the photoconductor 15. The developing roller 17 supplies the toner rubbed and charged to the photoconductor 15 by the developing voltage. The developing roller 17 supplies the toner to the electrostatic latent image formed in the photoconductor 15 to develop the electrostatic latent image into a toner image. An outer circumferential surface faces the transfer roller 25. A transferring bias voltage with an opposite polarity to the toner image is applied to the transfer roller 25 such that the toner image developed on the photoconductor 15 is transferred to the printable medium P. The toner image is transferred to the printable medium P by an electrostatic force and a mechanical pressure working between the photoconductor 15 and the transfer roller 25. The waste toner collector 80 scratches and collects the toner remaining on the surface of the photoconductor 15 after transferring of the toner image is finished.

The fuser 30 includes a heat roller 31 and a pressing roller 33 facing the heat roller 31. The fuser 30 applies heat and pressure on the toner image transferred to the printable medium P to fuse the toner image on the printable medium P. A discharging roller 35 discharges the printable medium P on which fusing is finished out of the image reading apparatus 100.

The scanning unit 99 includes a document tray 110, an automatic document feeder (ADF) 120, a document feed roller 130, a roller 150, a scanning module 160, and an alignment unit (not shown). A document ‘S’ is loaded on the document tray 110. Although a detailed structure of the ADF 120 is not shown, the ADF 120 picks up the document ‘S’ loaded on the document tray 110 one by one to convey the document ‘S’ towards a conveying path of the document ‘S’. Various control keys are provided and the operating state is displayed on a display panel 102. The conveying path of the document ‘S’ is formed in a sub-scanning direction substantially perpendicular to a main scanning direction in the main body 101 of the image reading apparatus. The conveying path of the document ‘S’ is formed by the document tray 110, the ADF 120, the document feed roller 130, and the roller 150, which are successively disposed. The main scanning direction is in the Y-axis direction substantially parallel to a width direction of the conveyed document ‘S’, and the sub-scanning direction is the X-axis direction substantially perpendicular to a main scanning direction, that is, the conveying direction of the document ‘S’.

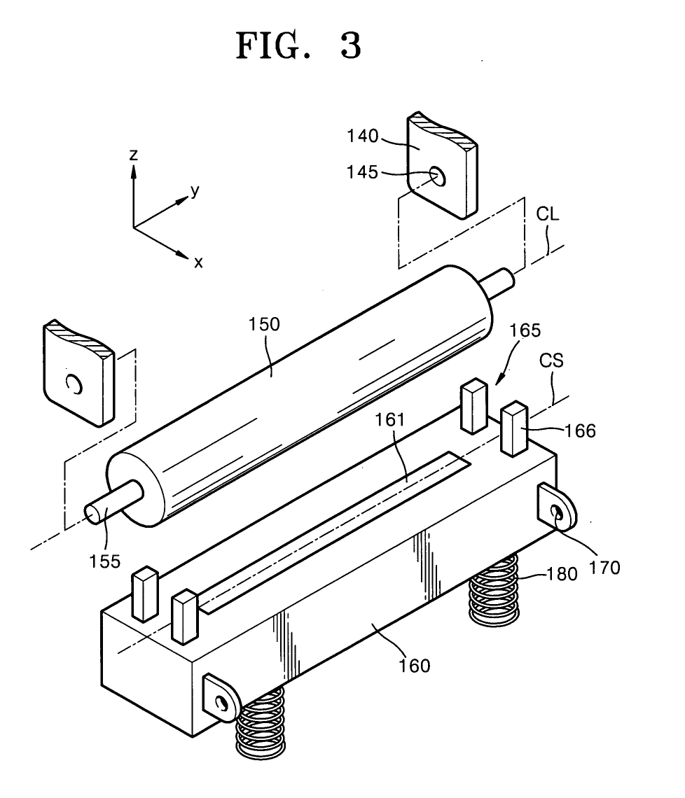

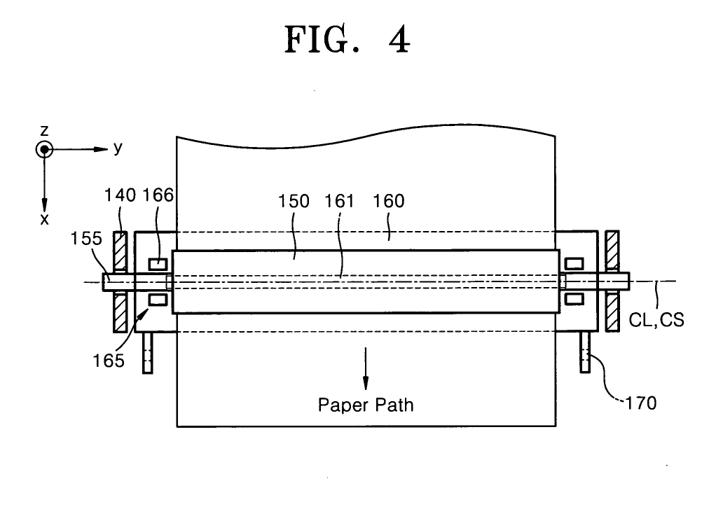

FIG. 3 is an exploded perspective view of an alignment unit according to an exemplary embodiment of the present invention. FIG. 4 is a top plan view of an alignment unit according to an exemplary embodiment of the present invention. In FIGS. 3 and 4, a bushing 140, the roller 150, the scanning module 160, and the alignment unit are illustrated.

The scanning module 160 includes a lens unit 161 and an image sensor (not shown). The lens unit 161 focuses a laser that is reflected on the document ‘S’ and contains the image information on the image sensor provided inside the scanning module 160. The image sensor converts the laser focused by the lens unit 161 into an electrical signal, and transmits the electrical signal to a signal processing unit (not shown). The signal processing unit abstracts an image data from the electrical signal received from the image sensor. The abstracted image data is sent to the printing unit 98 to be printed on the printable medium P or may be transmitted to a communication network by a facsimile module (not shown).

Although not shown, a contact image sensor (CIS) may be used as an image sensor. When a charge-coupled device (CCD) line sensor is used as an image sensor, the document ‘S’ may be read to a high resolution. However, the cost and the volume of the scanning module 160 increases, because a laser path with a predetermined length should be formed to align a laser focus on the surface of the CCD line sensor. Alternatively, the CIS has the limitation that the CIS has a lower resolution and needs to contact the surface of the document ‘S’ to obtain a clear image quality due to a short focus distance compared to the CCD line sensor. However, the CIS saves the costs necessary for designing or manufacturing the scanning module 160 and miniaturizes the apparatus because the CIS is manufactured as a module including a laser source (not shown), a mirror (not shown), and the lens unit 161, and so forth, therein.

The bushing 140 is formed in the main body 101 to support a rotation shaft 155 of the roller 150. The rotation shaft 155 of the roller may be inserted into a bushing hole 145 formed in the bushing 140, thereby being supported. The roller 150 conveys the document ‘S’ in a sub scanning direction, while rotating around the rotation shaft 155. The rotation shaft 155 is disposed substantially parallel to a main scanning direction by the bushing 140 disposed in the main body 101. This disposition substantially prevents the document ‘S’ from being obliquely read. That is, both the conveying path of the document ‘S’ and the bushing 140 are aligned in a direction based on the main body 101. Therefore, the shaft 155 of the roller 150 may be regarded as being substantially perpendicular to a conveying direction of the document ‘S’.

The scanning module 160 faces the roller 150 to read the document ‘S’ along the virtual scanning line ‘CS’. Although not shown, the alignment unit is formed integrally with the scanning module 160 and aligns the scanning module 160 such that the scanning line ‘CS’ is substantially parallel to a main scanning direction. The scanning module 160 may be aligned based on the rotation shaft 155 of the roller 150 controlled by the bushing 140.

The alignment unit includes restriction units 165. The restriction units 165 are preferably formed integrally with the scanning module 160 and disposed at both end portions of the scanning module 160 along the scanning line ‘CS’, as shown in FIGS. 3 and 4, which facilitates reducing a positioning error between the scanning line ‘CS’ and the restriction units 165 and also saves costs and miniaturizes the apparatus.

The restriction units 165 align the scanning module 160 such that the scanning line ‘CS’ is substantially parallel to a main scanning direction by contacting an outer circumference of both end portions of the rotation shaft 155.

The restriction units 165 include a pair of protrusions 166. The protrusions 166 protrude from the scanning module 160 towards the rotation shaft 155. The pair of protrusions 166 are axially symmetrical with respect to the scanning line ‘CS’, such that the protrusions of each pair are substantially equally spaced from the scanning line ‘CS.’ The rotation shaft 155 is inserted between a pair of protrusions 166. The pair of protrusions 166 contact an outer circumference of the rotation shaft 155 at opposite positions in a radial direction of the rotation shaft 155. The rotation shaft 155 of the roller 150 is aligned by the bushing 140, and the scanning module 160 is aligned by the rotation shaft 155 of the roller 150, both being based on the main body 101. Referring to FIG. 4, the axial center line ‘CL’ of the roller 150 and the rotation shaft 155 and the scanning line ‘CS’ are aligned in a substantially parallel direction to correspond to a main scanning direction.

The roller 150 and the scanning module 160 are preferably in contact to generate a force for conveying the document ‘S’ by friction. Additionally, when the CIS is included in the scanning module 160, the document ‘S’ is preferably thoroughly adhered to the lens unit 161 of the scanning module 160 to obtain clear image quality. For this, an elastic member 180 may be provided. The elastic member 180 applies an elastic force to the scanning module 160 to contact the scanning module 160 with an outer circumference of the roller. The scanning module 160, which is supported by the elastic member 180, moves in a direction to be closely adhered to the roller 150. A hinge member 170 may be provided in the scanning module 160, and the hinge member 170 hinges the scanning module 160 to the main body 101.

When the width of the document ‘S’ to be read is shorter than the length of a main scanning direction of the scanning line ‘CS’ or the lens unit 160, a peripheral region of the document ‘S’ (that is, a region outside of the surface of the document) except the surface of the document may be read into the black color. When the laser scanned in a peripheral region of the document ‘S’ is reflected towards the lens unit 161, the peripheral region of the document ‘S’ is preferably read as white color. For this, the roller 150 may extend longer than the allowable maximum width of the readable document ‘S’ in a main scanning direction, of which an outer circumference has the white color.

According to the image reading apparatus of an exemplary embodiment of the present invention, as described above, the location accuracy of the roller is improved because the rotation shaft of the roller is fixed to the main body of the image reading apparatus. Additionally, accurate alignment may be performed because the scanning module is guided by the rotation shaft of the roller. Additionally, the number of components is reduced, the cumulative tolerance is reduced, and miniaturization is facilitated because the alignment unit is formed integrally with the scanning module.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image reading apparatus, comprising:
a main body in which a conveying path of a document is formed;
a roller rotatably supported in the main body to convey the document in a sub-scanning direction while rotating around a rotation shaft;
a scanning module facing the roller and reading the document along a virtual scanning line; and
an alignment unit formed integrally with the scanning module and guided by the rotation shaft to align a scanning line of the scanning module and the roller in a substantially parallel direction.

2. The image reading apparatus of claim 1, wherein the alignment unit comprises restriction units disposed at both end portions of the scanning module along the scanning line.

3. The image reading apparatus of claim 2, wherein each of the restriction units comprises a pair of protrusions disposed at an axially symmetrical position with respect to the scanning line to contact and support the rotation shaft.

4. The image reading apparatus of claim 3, wherein the pair of protrusions contact an outer circumference of the rotation shaft at opposite positions in a radial direction of the rotation shaft.

5. The image reading apparatus of claim 1, further comprising an elastic member applying an elastic force to the scanning module to contact the scanning module to the roller.

6. The image reading apparatus of claim 5, wherein the scanning module comprises a hinge member hinging the scanning module to the main body.

7. The image reading apparatus of claim 1, wherein the roller extends longer than a maximum width of a readable document, and an outer circumference of the roller has white color such that a peripheral region of the document is read as white color.

8. The image reading apparatus of claim 1, wherein the scanning module comprises a CIS (contact image sensor) reading an image at a position closely adhered to a surface of the document.

9. The image reading apparatus of claim 1, further comprising a printing unit printing an image on a printable medium.

10. The image reading apparatus of claim 1, wherein the roller shaft is received by a bushing connected to the main body of the image reading apparatus.

11. The image reading apparatus of claim 1, wherein the roller shaft is substantially perpendicular to the conveying direction of the document.

12. An image reading apparatus, comprising:
a roller rotatably supported in a main body of the image reading apparatus;
a scanning module facing the roller to read a document conveyed between the scanning module and the roller along a virtual scanning line; and
an alignment unit formed with the scanning module to align a scanning line of the scanning module and the roller in a substantially parallel direction.

13. The image reading apparatus of claim 12, wherein a bushing connected to the main body receives the roller.
